(19) United States
(12) Patent Application Publication
(10) Pub. No.: US 2015/0236910 A1
(43) Pub. Date: Aug. 20, 2015

(54) USER CATEGORIZATION IN COMMUNICATIONS NETWORKS

(71) Applicant: Telefonaktiebolaget L M Ericsson (publ), Stockholm (SE)

(72) Inventors: Subramanian SHIVASHANKAR, Chennai (IN); Priyesh Vijayan, Vellore (IN)

(21) Appl. No.: 14/182,337

(22) Filed: Feb. 18, 2014

(51) Int. Cl. H04L 12/24

(52) U.S. Cl. CPC H04L 41/0853; H04L 41/12

(57) ABSTRACT

There is provided categorization of users in a communications network. Information is acquired from a plurality of information sources in a communications network. The information is associated with a plurality of users of the communications network and represented by a multi-relation network representation. The multi-relation network representation comprises a plurality of node types and relationship types. At least one categorization criterion is acquired. A categorization routine is repeatedly to performed to determine a relation between the users. The users are categorized according to the determined relation.

### TECHNICAL FIELD

Embodiments presented herein relate to categorization of users, and particularly to a method, a network node, a computer program, and a computer program product for categorizing users in a communications network.

### BACKGROUND

In communications networks, there is always a challenge to obtain good performance and capacity for a given communications protocol, its parameters and the physical environment in which the communications network is deployed.

One parameter related to performance and capacity of the communications networks is the categorization of different users. Different users may require different services, Quality of Service (QoS) levels, etc.

Determination of categorization of different users may be based on machine learning. Categorization of different users may be used in contexts such as churn prediction, customer appetency prediction, customer up-selling value prediction, etc. Considering the market costs associated with such categorization of different users, one issue concerns accuracy of the categorization.

Information which may be used to categorize users may relate to utilizing consumer usage (voice/messaging services) information so as to identify churners by applying supervised learning techniques. Consumer data usage may be used to find interests of the users. Social media information may be used to find consumer trends, etc. Such rich information can be used to suggest service plans, add-on services, products, etc. to the user. This may help service operators to save/increase business by satisfying churners, influential users, (low/high) affinity users for a service, etc.

Different sources of data are commonly processed in the telecommunications domain. Examples involve call data information, broadband usage information, mobile money transactions, social media data, consumer profile in customer relationship management systems, etc. Utilizing a large number of such information sources may improve the categorization of the users.

In “Multi-label Collective Classification” by Kong et al in Proceedings of the SIAM International Conference on Data Mining, 2011, there is presented a multi-label collective classification approach to handle multiple sources of information (with one attribute/flat information and one relationship type). This approach is mainly based on correlation measures. However, it may still be difficult to efficiently capture all information (with multiple attributes/flat informations and multiple relationship types) and to efficiently use it in order to categorize users.

Hence, there is still a need for improved categorization of users in communications networks.

### SUMMARY

An object of embodiments herein is to provide improved categorization of users in communications networks.

The inventors of the enclosed embodiments have discovered that commonly, different sources of information are treated independently. But the inventors of the enclosed embodiments have realized that interaction between multiple sources of information can provide much richer information than a single source of information. Further, the inventors of the enclosed embodiments have discovered that commonly, mechanisms have been proposed that use both flat information and social network information together. But the inventors of the enclosed embodiments have realized that it may be beneficial to leveraging multiple sources of information, multiple relationship types, and multiple types of nodes in communications networks when categorizing its users.

A particular object is therefore to provide improved categorization of users in communications networks by considering information from a plurality of information sources and by considering multi-relation network representations.

According to a first aspect there is presented a method for categorizing users in a communications network. The method is performed by a network node. The method comprises acquiring information from a plurality of information sources in a communications network. The information is associated with a plurality of users of the communications network and represented by a multi-relation network representation. The multi-relation network representation comprises a plurality of node types and relationship types. The method comprises acquiring at least one categorization criterion. The method comprises repeatedly performing a categorization routine. The categorization routine comprises transforming the multi-relation network representation into a single-relation network representation representing an aggregated expected network comprising a single node type and a single relationship type by combining multiple node types and relationship types in the multi-relation network representation. The categorization routine comprises determining a relation between the users based on the at least one categorization criterion and by associating the acquired information with the aggregated expected network. The categorization routine comprises updating the multi-relation network representation based on the determined relation. The method comprises categorizing the users according to the determined relation.

Advantageously this provides improved categorization of users in communications networks.

Advantageously this provides a decision making mechanism which is able to leverage all sources of information.

Advantageously this enables handling of complex communications networks being multiple attribute type, multi-relational and multi-mode.

Advantageously this provides a joint model arranged to solve dependent tasks.

Advantageously this may provide calibrated results and/or reports utilizing both multiple sources of information and task dependencies efficiently.

According to a second aspect there is presented a network node for categorizing users in a communications network. The network node comprises a processing unit and a non-transitory computer readable storage medium. The non-transitory computer readable storage medium comprises instructions executable by the processing unit. The network node is operative to acquire information from a plurality of information sources in a communications network. The information is associated with a plurality of users of the communications network and represented by a multi-relation network representation, the multi-relation network representation comprising a plurality of node types and relationship types. The network node is operative to acquire at least one categorization criterion. The network node is operative to repeatedly perform a categorization routine. The categorization routine comprises transforming the multi-relation network representation into a single-relation network representation representing an aggregated expected network comprising a single node type and a single relationship type by combining multiple node types and relationship types in the multi-relation network representation. The categorization routine comprises determining a relation between the users based on the at least one categorization criterion and by associating the acquired information with the aggregated expected network. The categorization routine comprises updating the multi-relation network representation based on the determined relation. The network node is operative to categorize the users according to the determined relation.

According to a third aspect there is presented a computer program for categorizing users in a communications network, the computer program comprising computer program code which, when run on a processing unit, causes the processing unit to perform a method according to the first aspect.

According to a fourth aspect there is presented a computer program product comprising a computer program according to the third aspect and a non-transitory computer readable storage medium on which the computer program is stored.

It is to be noted that any feature of the first, second, third and fourth aspects may be applied to any other aspect, wherever appropriate. Likewise, any advantage of the first aspect may equally apply to the second, third, and/or fourth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2a is a schematic diagram showing functional modules of a network node according to an embodiment;

FIG. 2b is a schematic diagram showing functional units of a network node according to an embodiment;

FIG. 3 shows one example of a computer program product comprising computer readable means according to an embodiment;

FIGS. 4 and 5 are flowcharts of methods according to embodiments;

FIG. 6 is a schematic illustration of a multi-relation network representation;

FIG. 7 is a schematic illustration of a single-relation network representation; and

FIG. 8 is a plot showing rate of convergence according to an illustrative example.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

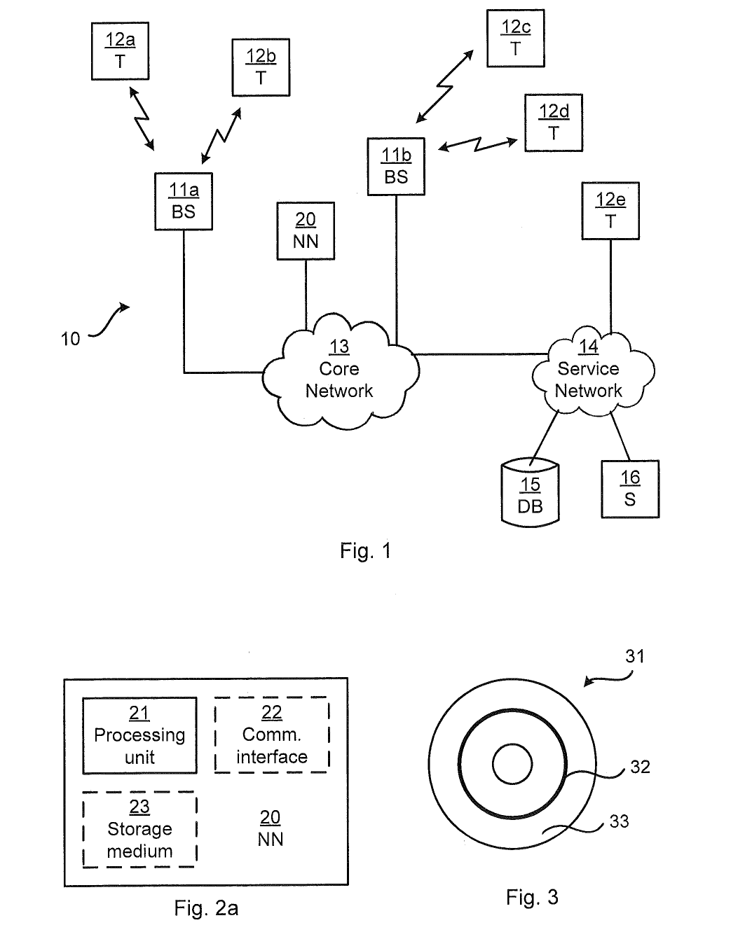

FIG. 1 is a schematic diagram illustrating a communication network 10 where embodiments presented herein can be applied. The communications network 10 may generally comply with any one or a combination of W-CDMA (Wideband Code Division Multiplex), LTE (Long Term Evolution), EDGE (Enhanced Data Rates for GSM Evolution, Enhanced GPRS (General Packet Radio Service)), CDMA2000 (Code Division Multiple Access 2000), etc., as long as the principles described hereinafter are applicable.

The communications network 10 comprises at least one base station 11a, 11b. In general terms, the communication network 10 may comprise a plurality of base stations 11a, 11b. The communications network 10 may comprise any combination of base stations 11a, 11b in the form of an evolved Node B (eNodeB or eNB), a Node B, a Base Transceiver Stations (BTS) or a Base Station Subsystem (BSS), a WiFi access point (AP), etc.

The at least one base station 11a, 11b is operatively to a core network 13 and arranged to function as a radio base station so as to provide network access to a service network 14 in the form or radio connectivity to at least one wireless end-user terminal (T) 12a, 12b, 12c, 12d. The at least one wireless end-user terminal 12a, 12b, 12c, 12d is thereby enabled services and data as provided by the service network 14. An end-user terminal 12e may further have a wired connection to the service network 14. The at least one end-user terminal 12a, 12b, 12c, 12d, 12e may be any combination of a user equipment (UE), a smartphone, a mobile phone, a tablet computer, a laptop computer, a stationary computer, a machine-to-machine device, etc. Each end-user terminal 12a, 12b, 12c, 12d, 12e may be may be associated with at least one end-user (hereinafter simply referred to as a user).

The at least one base station 11a, 11b, the end-user terminals 12a, 12b, 12c, 12d, 12e, the core network 13, the service network 14, the at least one database 15, and the server 16 will collectively be referred to information sources.

The communications network 10 further comprises a network node 20, the functionality of which will be further disclosed below.

The service network 14 may be an internet protocol (IP) based service network 14 and may comprise and/or be operatively connected to at least one database (DB) 15 and/or at least one server (S) 16 providing data services to the service network 14 and devices operatively connected thereto. The database 15 may store webpage content, etc. The server 16 may be a web server, etc. In this way, the at least one end-user terminal 12a, 12b, 12c, 12d, 12e is enabled to request content, such as video, audio, images, text, etc., from the at least one database 15 and/or the at least one server 16. The content may be delivered in a content flow by streaming using a suitable protocol, e.g. HTTP (Hypertext transfer protocol) or RTP (Real-time Transport Protocol). Control from the at least one end-user terminal 12a, 12b, 12c, 12d, 12e to at least one database 15 and/or the at least one server 16 may be transmitted using a suitable protocol, such as HTTP or RTSP (Real-Time Streaming Protocol).

In general terms, resources are allocated to the at least one end-user terminal 12a, 12b, 12c, 12d upon establishing a connection to a base station 11a, 11b over the radio interface. The allocated resources are determined by network parameters and thus influence the communications link between the at least one end-user terminal 12a, 12b, 12c, 12d and the base station 11a, 11 b. Data traffic characteristics may be utilized to optimize, or at least improve, the use of resources allocated to the at least one end-user terminal 12a, 12b, 12c, 12d.

The embodiments disclosed herein relate to categorizing users in a communications network 10. In order to obtain categorization of users in the communications network 10 there is provided a network node 20, a method performed by the network node 20, a computer program comprising code, for example in the form of a computer program product, that when run on a network node 20, causes the network node 20 to perform the method.

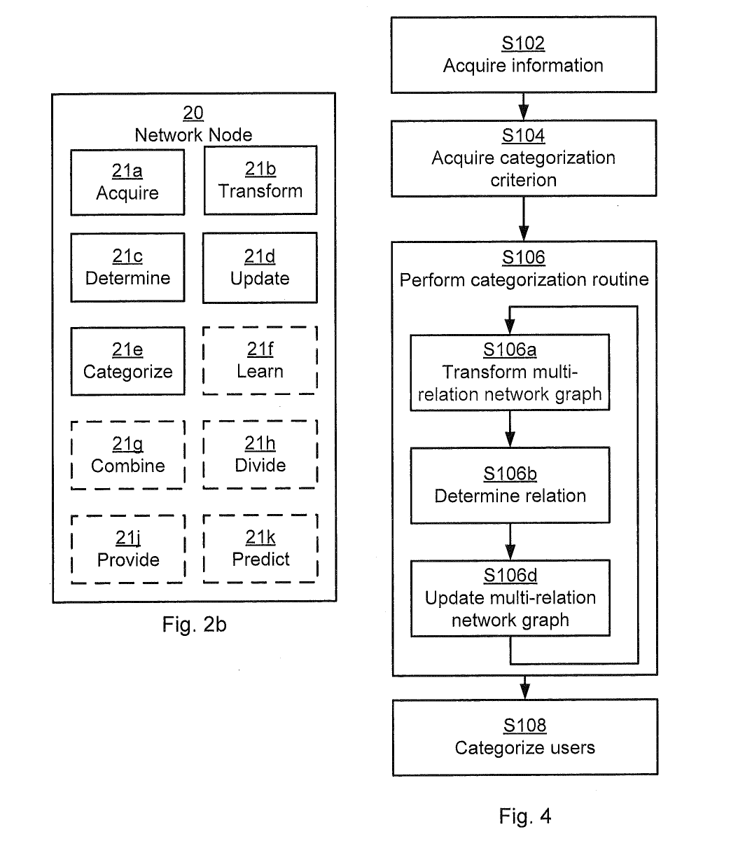

FIG. 2a schematically illustrates, in terms of a number of functional modules, the components of a network node 20 according to an embodiment. A processing unit 21 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 31 (as in FIG. 3), e.g. in the form of a storage medium 23. Thus the processing unit 21 is thereby arranged to execute methods as herein disclosed. The a storage medium 23 may also comprise persistent storage, which, for example, can be any single one or combination of magnetic memory, optical memory, solid state memory or even remotely mounted memory. The network node 20 may further comprise a communications interface 22 for communications with information sources 11a-b, 12a-e, 13, 14, 15, 16 of the communications network 1. As such the communications interface 22 may comprise one or more transmitters and receivers, comprising analogue and digital components and a suitable number of antennas, ports or interfaces. The processing unit 21 controls the general operation of the network node 20 e.g. by sending data and control signals to the communications interface 22 and the storage medium 23, by receiving data and reports from the communications interface 22, and by retrieving data and instructions from the storage medium 23. Other components, as well as the related functionality, of the network node 20 are omitted in order not to obscure the concepts presented herein.

The network node 20 may be provided as a standalone device or as a part of a further device. For example, the network node 20 may be provided in base station 11a, 11b, or in a server 16. The network node 20 may be provided as an integral part of the base station 11a, 11b or server 16. That is, the components of the network node 20 may be integrated with other components of the base station 11a, 11b or server 16; some components of the base station 11a, 11b or server 16 and the network node 20 may be shared. For example, if the base station 11a, 11b or server 16 as such comprises a processing unit, this processing unit may be arranged to perform the actions of the processing unit 21 associated with the network node 20. Alternatively the network node 20 may be provided as a separate unit in the base station 11a, 11b or server 16.

FIG. 2b schematically illustrates, in terms of a number of functional units, the components of a network node 20 according to an embodiment. The network node 20 of FIG. 2b comprises a number of functional units; an acquire unit 21a, a transform unit 21b, a determine unit 21c, and update unit 21d, and a categorize unit 21e. The network node 20 of FIG. 2b may further comprises a number of optional functional units, such as any of a learn unit 21f, a combine unit 21g, a divide unit 21h, a provide unit 21j, and a predict unit 21k. The functionality of each functional unit 21a-k will be further disclosed below in the context of which the functional units may be used. In general terms, each functional unit 21a-k may be implemented in hardware or in software. The processing unit 21 may thus be arranged to from the storage medium 23 fetch instructions as provided by a functional unit 21a-k and to execute these instructions, thereby performing any steps as will be disclosed hereinafter.

FIGS. 4 and 4 are flow chart illustrating embodiments of methods for categorizing users in a communications network 10. The methods are performed by the network node 20. The methods are advantageously provided as computer programs 32. FIG. 3 shows one example of a computer program product 31 comprising computer readable means 33. On this computer readable means 33, a computer program 32 can be stored, which computer program 32 can cause the processing unit 21 and thereto operatively coupled entities and devices, such as the communications interface 22 and the storage medium 23 to execute methods according to embodiments described herein. The computer program 32 and/or computer program product 31 may thus provide means for performing any steps as herein disclosed.

In the example of FIG. 3, the computer program product 31 is illustrated as an optical disc, such as a CD (compact disc) or a DVD (digital versatile disc) or a Blu-Ray disc. The computer program product 31 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory. Thus, while the computer program 32 is here schematically shown as a track on the depicted optical disk, the computer program 32 can be stored in any way which is suitable for the computer program product 31.

Reference is now made to FIG. 4 illustrating a method for categorizing users in a communications network 10 according to an embodiment. The method is performed by the network 20.

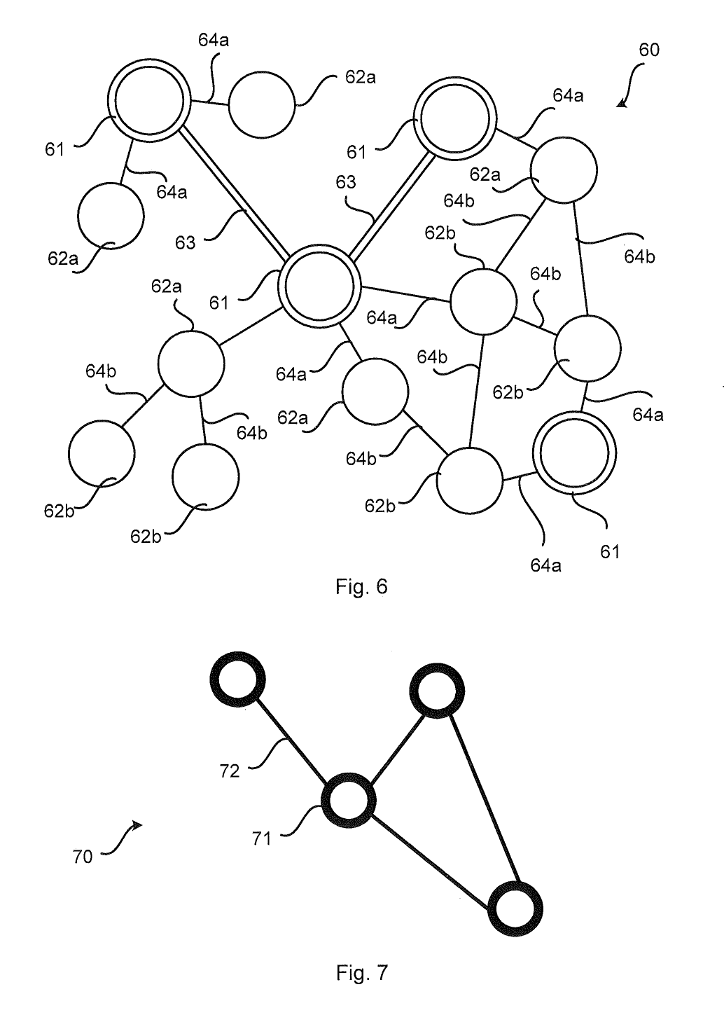

The categorization is based on using information from a plurality of information sources 11a-b, 12a-e, 13, 14, 15, 16 in the communications network 10. Hence, the processing unit 21 of the network node is arranged to, in a step S102, acquiring information from a plurality of information sources 11a-b, 12a-e, 13, 14, 15, 16 in the communications network 10. The information is associated with a plurality of users of the communications network 10 and is represented by a multi-relation network representation 60. FIG. 6 schematically illustrates a multi-relation network representation 60. The multi-relation network representation comprises a plurality of node types 61, 62a, 62b and relationship types 63, 64a, 64b. The node type 61 may correspond to a user and the node types 62a-b may correspond to different properties of the user. The relationship type 63 may be defined by relations between users (i.e., between nodes of node type 61) and the relationship types 64a-b may be defined by relations between different properties of the user.

There may be different aspects relating to different criterion according to which the users are to be categorized. The processing unit 21 of the network node is therefore arranged to, in a step S104, acquire at least one categorization criterion. The at least one categorization criterion may be acquired from at least one of the information sources 11a-b, 12a-e, 13, 14, 15, 16.

The herein disclosed embodiments are based on performing a categorization routine. The categorization routine is repeatedly performed. The categorization routine comprises combining multiple link/relationship networks with respect to each node type into an aggregated expected network. The aggregated network may thus be regarded as the mathematical expectation of the combination of multiple link/relationship networks with respect to each node type. The processing unit 21 of the network node is thus arranged to, in a step S106, repeatedly perform a categorization routine. Details of this categorization routine will now be disclosed.

The categorization routine comprises, in a step S106a, transform the multi-relation network representation 60 into a single-relation network representation 70. FIG. 7 schematically illustrates a single-relation network representation 70. The single-relation network representation 70 represents an aggregated expected network and comprises a single node type 71 and a single relationship type 72. The transformation involves combining multiple node types 61, 62a, 62b and relationship types 63, 64a, 64b in the multi-relation network representation 60. Examples of how the multiple node types 61, 62a, 62b and relationship types 63, 64a, 64b may be combined will be further disclosed below.

The categorization routine comprises leveraging multiple information sources 11a-b, 12a-e, 13, 14, 15, 16 together with the aggregated expected network (for each node type) by using an ensemble of multiple attributed networks. The categorization routine thus comprises, in a step S106b, determine a relation between the users based on the at least one categorization criterion and by associating the acquired information with the aggregated expected network. Further details related thereto will be disclosed below.

The categorization routine comprises, in a step S106d, updating the multi-relation network representation based on the determined relation.

After having completed (at least one iteration of) the categorization routine, the users are categorized. Hence, the processing unit 21 of the network node is arranged to, in a step S108, categorize the users according to the determined relation.

Embodiments relating to further details of categorizing users in a communications network 10 will now be disclosed.

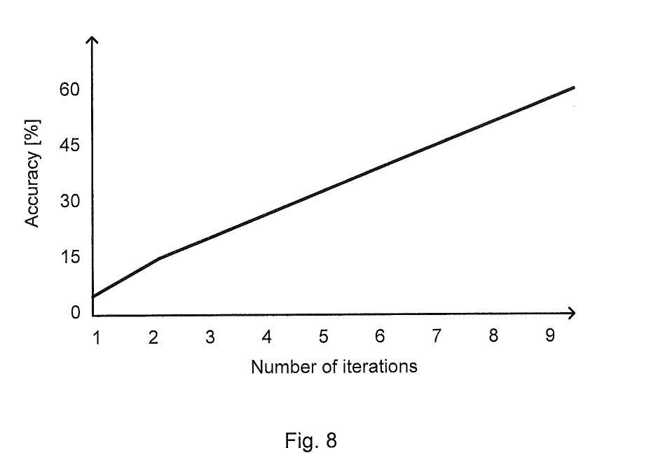

There may be different ways to determine how many iteration of the categorization routine to perform. Different embodiments relating thereto will now be described in turn. FIG. 8 is a plot showing rate of convergence according to an illustrative example by plotting accuracy (in percent) as a function of the number of iterations made of the categorization routine. In more detail, a number of iterations of the herein disclosed categorization routine were performed and after each iteration a comparison was made to the true outcome, i.e., the true categorization of the users according to the given categorization criterion. The plot shows the results of an example where predictions of categorizations were made based on a data set representing information acquired from a plurality of information sources 11a-b, 12a-e, 13, 14, 15, 16 where 10% of the originally provided information was tagged (examples of tagged information are provided below). According to the present example the accuracy of the predictions are about 60% after g iterations.

For example, the steps of the categorization routine may be repeated until convergence. That is, the categorization routine may be repeated until the relation changes less than a predetermined threshold value between two consecutive iterations thereof. This predetermined threshold value may be given in percent, such as 5%, 10%, or 15% depending on the accuracy needed.

For example, the steps of the categorization routine may be repeated a predetermined number of times. That is, the categorization routine may be repeated for a predetermined amount of times, such as 5, 10, or 15 times.

There may be different examples of information and types of information sources. For example, each one of the information sources 11a-b, 12a-e, 13, 14, 15, 16 may be an independent and identically distributed information source.

For example, at least parts of the information may be tagged. The tagged information may relate to different properties. The tagged information may be represented by the plurality of node types 61, 62a, 62b and/or the plurality of relationship types 63, 64a, 64b in the multi-relation network representation 60. Hence, each node type 61, 62a, 62b may correspond to one type of tagged information, and/or each relationship type 63, 64a, 64b may correspond to one type of tagged information. Examples include, but are not limited to any combination of call and/or messaging patterns of the users, call and/or messaging graphs of the users, web browsing information of the users, network graphs, user activities, and/or group affiliation of the users in an online social networking service and/or an online microblogging service, demographics of the users in the communications network, and infrastructure information of a network coverage area of the communications network. In this respect an online social networking service may be defined as providing an online, computer implemented, platform to build social networks or social relations among users who, for example, share interests, activities, backgrounds, or real-life connections. An online social networking service may comprise of a representation of each user (often as a user profile), the social links of the user, and a variety of additional services. Most social network services are web-based and provide means for users to interact over the Internet, such as e-mail and instant messaging. The online social networking service may enable users to share digital documents such as ideas, pictures, posts, activities, events, and interests with other users in their network. The herein disclosed embodiments may thus be applied in different scenarios which involve multiple sources of information. By utilizing a plurality of information sources 11a-b, 12a-e, 13, 14, 15, 16 providing information of users, such as relating to the above disclosed types of tagged information, the users may be categorized based on a plurality of properties (as given by the different tags), thus resulting in accurate categorization of users.

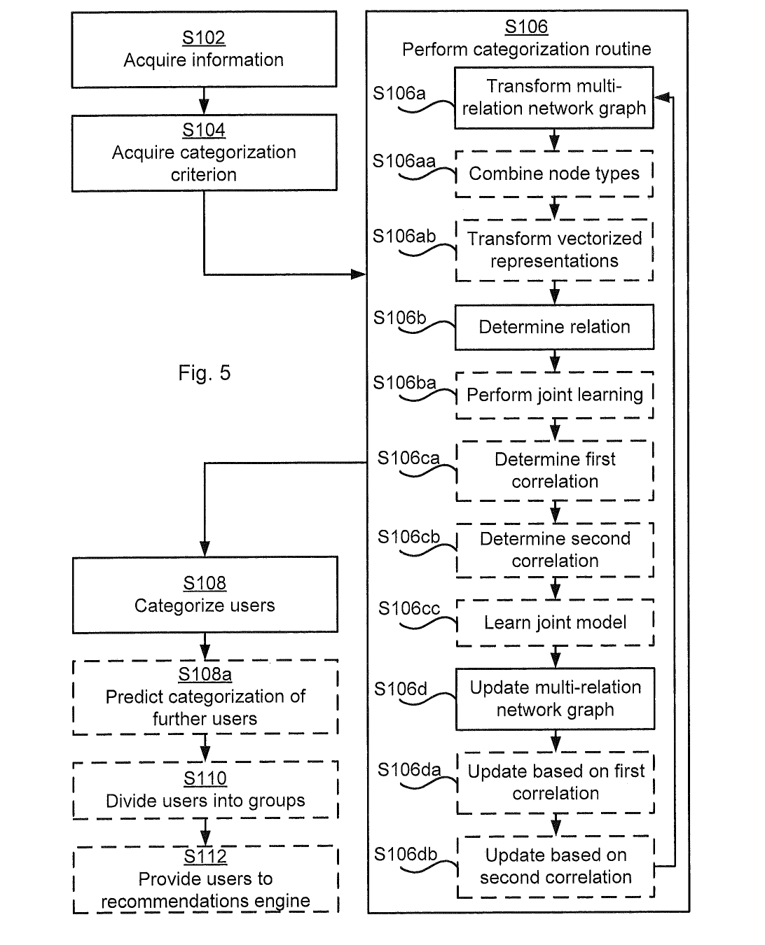

Reference is now made to FIG. 5 illustrating methods for categorizing users in a communications network 10 according to further embodiments.

Each categorization criterion may correspond to a task. The herein disclosed embodiments may utilize all information sources 11a-b, 12a-e, 13, 14, 15, 16 and task correlations to enable multi-task prediction. This may involve to simultaneously leveraging information from the information sources 11a-b, 12a-e, 13, 14, 15, 16, relationship information, and any task correlations. The categorization routine may therefore comprise to, in a step S106ca, determine a correlation between the plurality of relationship types based on the plurality of information sources. This correlation may be used to update the multi-relation network representation 60. The categorization routine may comprise to, in a step S106da, update the multi-relation network representation 60 also based on the correlation between the plurality of relationship types.

Hence, such an update may assign predicted tags to un-tagged information, thus resulting in more tagged information in the multi-relation network representation 60.

At least two categorization criteria may be acquired. The categorization routine may then comprise to, in a step S10cb, determine a correlation between the at least two categorization criteria. The categorization routine may then comprise to, in a step S106db, update the multi-relation network representation also based on the correlation between the at least two categorization criteria.

As a non-limiting, illustrating example, consider a scenario based on the categorization criteria (i.e., tasks) appetency and upselling related to users of the communications network 10. Assume that the appetency and the upselling tasks have a dependency (i.e., a correlation) of 0.7. This would indicate that if a user has greater appetency for a service offered in the communications network 10, this user will have a corresponding high upselling value for as well. The information gained from the correlation measure to calibrate certain results. For example, if the correlation between churn and appetency is 0.1, and if the churn and appetency probabilities for a particular user are 0.8 and 0.9 respectively, this would indicate a possible discrepancy in the data/results because a user with high churn probability is expected to have low appetency probability. Alternatively, this also raises a necessity for an intervention, where a user with high appetency value might churn for a reason such as some other users related to this user may be moving to another service provider. It may thus require application of a different business support strategy to retain this user from a typical churner who churns because of not liking the service. The correlation measure may also be used to re-rank a list of users. For example, between two users who have their churn and appetency scores as 0.3 and 0.8, and 0.7 and 0.8, respectively, the latter user will get lesser rank for net “happiness” since it has a higher churn probability. In order to achieve this, for each task, the predictions with respect to other tasks may be appended to a feature vector while learning and inference.

There may be different ways to transform the multi-relation network representation 60 into the single-relation network representation 70 as in step S106a.

Different categorization criteria relating to different tasks may be treated separately and a model is built where information relating to these different tasks may compliment each other. In order to simultaneously learn from both data networks and other vector based feature sets, the multi-relation network representation 60 may be transformed into a vector format by representing each node as the label distribution of it neighboring nodes. In general terms, this transformation may be achieved by using a function f that maps a multiple vectorized representations of links L₁, L₂, . . . Lₙ, where n is the number of different types of links and Lᵢ are task specific vectorized link descriptions into a single link representation L*. That is:

f:(L₁, L₂ . . . Lₙ)→L*.

For example, for categorization based on classification, properties such as label distribution, sum, mean, median, mode of label counts of neighbors may be used to determine the function f. For example, for categorization based on regression, f could be determined to produce an average value of neighbors y*. Particularly, according to an embodiment the processing unit 21 of the network node is arranged to, in an optional step S106aa, transform the multi-relation network representation 60 in step S106a by combining the plurality of node types 61, 62a, 62b into the single node type 71; and by, in an optional step S106ab, transforming multiple vectorized representations of links between each pair of linked nodes in the multi-relation network representation 60 to a single vectorized representation between each pair of nodes 71 in the single-relation network representation.

There may be different ways to determine the relation between the users as in step S106b. In general terms, the determination may be based on learning. Attributes (of the plurality of information sources 11a-b, 12a-e, 13, 14, 15, 16) 30 and links between nodes are handled as two different types of views of the communications network 10. Multi-source learning may alternately be performed across these types. This may be achieved by learning a hypothesis function Hₐ on attributes and Hₗ* on link types. Hₐ teaches Hₗ* and Hₗ* teaches Hₐ alternately. Since there will be multiple attribute views, ensemble learning may be used to combine them. Particularly, according to an embodiment the processing unit 21 of the network node is arranged to, in an optional step S106ba, determine the relation in step S106b by repeatedly performing multi-score learning between the acquired information by learning a first hypothesis function, Hₐ, on attributes of the acquired information and links between nodes in the aggregated expected network by learning a second hypothesis function, Hₗ*, on link types of the aggregated expected network.

There may be different ways to determine the correlation as in step S106ca. According to an embodiment the processing unit 21 of the network node is arranged to, in an optional step S106cc, determine the correlation in step S106ca by learning a joint model of the plurality of information sources explicitly capturing the correlation between the plurality of relationship types.

There may be different ways to model the multi-relation network representation and the single-relation network representation. Different examples relating thereto will now be described in turn.

Combining all the information given above, a joint model for the multi-relation network representation can be expressed as follows:

argmax Σ^{T}_{iε1}ΣE^{V}_{kε1}θᵢᵥ(Vₖ)+Σ^{L}_{jε1}θᵢₗ(Lⱼ)+Σ^{V}_{kε1}Σ^{L}_{jε1}Ψᵢ(Vₖ,Lⱼ),

with an objective to find θ such this expression is maximized, where i=1, . . . , T denotes task i, Vk denotes attributes for user k, Lj denotes relationship types in domain j, θ is estimated based on said information sources, and Ψ denotes task based correlations.

With transformed global link view from multiple relations, the single-relation network representation can be expressed as follows:

argmax Σ^{T}_{iε1}Σ^{V}_{kε1}θᵢᵥ(Vₖ)+θᵢ*(L*)+Σ^{V}_{kε1}Ψᵢ(Vₖ,L*),

with an objective to find θ such said this expression is maximized, where i=1, . . . , T denotes task i, Vk denotes attributes for user k, L* denotes relationship type, θ is the parameter estimated on the sources, and Ψ denotes task based correlations.

The learning procedure may be performed repeatedly until convergence for each mode type m in the communications network 10. For example, this can capture interactions between users, services, and network resource configurations of the communications network 10. Particularly, the single-relation network representation for each mode type m can be expressed as follows:

argmax Σ^{M}_{mε1}Σ^{T}_{iε1}Σ^{V}_{kε1}θᵢₘᵥ(Vₖₘ)+θᵢ*(Lₘ*)+Σ^{V}_{kε1}Ψᵢₘ(Vₖₘ,Lₘ*)

with an objective to find θ such that this expression is maximized. The method to transform/fuse multiple relations to one, multi-source learning and joint model capturing task correlation (Ψi) can be realized in multiple ways given the generic setup as mentioned above.

There may be different ways to utilize the categorization determined in step S108. Different examples relating thereto will now be described in turn.

For example, the categorization may be used for prediction of further users. According to an embodiment the processing unit 21 of the network node is thus arranged to, in an optional step S108a, predict categorization of further users of the communications network based on the on the categorized users.

For example, the categorization may be used to divide users into groups. According to an embodiment the processing unit 21 of the network node is thus arranged to, in an optional step S110, divide the users into at least two groups based on the categorized users.

For example, the categorization may be used as input to a recommendations engine. According to an embodiment the processing unit 21 of the network node is thus arranged to, in an optional step S112, provide at least one of the at least two groups to a recommendations engine for the users. There may be different examples of recommendations engines. For examples, the recommendations engine may relate to services, such as subscriptions, offered in the communications network, or network resource configurations, such as resource allocation, associated with the users. Hence, the herein disclosed embodiments enable implementation of highly personalized mobile advertisement system that can predict the interests of users.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

We claim:

1. A method for categorizing users in a communications network, the method being performed by a network node, comprising the steps of:
acquiring information from a plurality of information sources in a communications network, said information being associated with a plurality of users of said communications network and represented by a multi-relation network representation, said multi-relation network representation comprising a plurality of node types and relationship types;
acquiring at least one categorization criterion;
repeatedly performing a categorization routine comprising:
transforming said multi-relation network representation into a single-relation network representation representing an aggregated expected network comprising a single node type and a single relationship type by combining multiple node types and relationship types in said multi-relation network representation;
determining a relation between said users based on said at least one categorization criterion and by associating said acquired information with said aggregated expected network; and
updating said multi-relation network representation based on said determined relation;
and
categorizing said users according to said determined relation.

2. The method according to claim 1, wherein said categorization routine further comprises:
determining a first correlation between said plurality of relationship types based on said plurality of information sources; and
updating said multi-relation network representation also based on said first correlation.

3. The method according to claim 2, wherein determining said correlation further comprises:
learning a joint model of said plurality of information sources explicitly capturing said correlation between said plurality of relationship types.

4. The method according to claim 1, wherein at least two categorization criteria are acquired, and wherein said categorization routine further comprises:
determining a second correlation between said at least two categorization criteria; and
updating said multi-relation network representation also based on said second correlation.

5. The method according to claim 1, wherein transforming said multi-relation network representation further comprises:
combining said plurality of node types into said single node type; and
transforming multiple vectorized representations of links between each pair of linked nodes in said multi-relation network representation to a single vectorized representation between each pair of nodes in said single-relation network representation.

6. The method according to claim 1, wherein determining said relation further comprises:
repeatedly performing multi-score learning between said acquired information by learning a first hypothesis function, Hₐ, on attributes of said acquired information and links between nodes in said aggregated expected network by learning a second hypothesis function, Hₗ*, on link types of said aggregated expected network.

7. The method according to claim 1, wherein each one of said information sources is an independent and identically distributed information source.

8. The method according to claim 1, wherein said categorization routine is repeated until said relation changes less than a predetermined threshold value between two consecutive iterations thereof.

9. The method according to claim 1, wherein said categorization routine is repeated for a predetermined amount of times.

10. The method according to claim 1, wherein at least parts of said information is tagged, said tagged information relating to at least one of:
call and/or messaging patterns of said users;
call and/or messaging graphs of said users;
web browsing information of said users;
network graphs, user activities, and/or group affiliation of said users in an online social networking service and/or an online microblogging service;
demographics of said users in said communications network; and
infrastructure information of a network coverage area of said communications network.

11. The method according to claim 10, wherein said tagged information is represented by said plurality of node types and/or said plurality of relationship types in said multi-relation network representation.

12. The method according to claim 1, further comprising:
dividing said users into at least two groups based on said categorized users.

13. The method according to claim 12, further comprising:
providing at least one of said at least two groups to a recommendations engine for said users.

14. The method according to claim 13, wherein said recommendations engine relates to services, such as subscriptions, offered in said communications network, or network resource configurations, such as resource allocation, associated with said users.

15. The method according to claim 1, further comprising:
predicting categorization of further users of said communications network based on said on said categorized users.

16. The method according to claim 1, wherein said multi-relation network representation is modelled according to a first expression defined as:
argmax Σ^{T}_{iε1}Σ^{V}_{kε1}θᵢᵥ(Vₖ)+Σ^{L}_{jε1}θᵢₗ(Lⱼ)+Σ^{V}_{kε1}Σ^{L}_{jε1}Ψᵢ(Vₖ,Lⱼ)
with an objective to find 0 such that said first expression is maximized, where i=1, . . . , T denotes task i, Vk denotes attributes for user k, Lj denotes relationship types in domain j, θ is estimated based on said information sources, and Ψ denotes task based correlations.

17. The method according to claim 1, wherein said single-relation network representation is modelled according to a second expression defined as:
argmax Σ^{T}_{iε1}Σ^{V}_{kε1}θᵢᵥ(Vₖ)+θᵢ*(L*)+Σ^{V}_{kε1}Ψᵢ(Vₖ,L*),
with an objective to find θ such that said second expression is maximized, where i=1, . . . , T denotes task i, Vk denotes attributes for user k, L* denotes relationship type, θ is the parameter estimated on the sources, and Ψ denotes task based correlations.

18. The method according to claim 1, wherein said single-relation network representation for each mode type m is modelled according to a third expression defined as:
argmax Σ^{M}_{mε1}Σ^{T}_{iε1}Σ^{V}_{kε1}θᵢₘᵥ(Vₖₘ)+θᵢ*(Lₘ*)+Σ^{V}_{kε1}Ψᵢₘ(Vₖₘ,Lₘ*)
with an objective to find θ such that said third expression is maximized, where i=1, . . . , T denotes task i, Vk denotes attributes for user k, L* denotes relationship type, θ is the parameter estimated on the sources, and Ψ denotes task based correlations.

19. A network node for categorizing users in a communications network, the network node comprising a processing unit and a non-transitory computer readable storage medium, said non-transitory computer readable storage medium comprising instructions executable by said processing unit whereby said network node is operative to:
acquire information from a plurality of information sources in a communications network, said information being associated with a plurality of users of said communications network and represented by a multi-relation network representation, said multi-relation network representation comprising a plurality of node types and relationship types;
acquire at least one categorization criterion;
repeatedly perform a categorization routine comprising:
transforming said multi-relation network representation into a single-relation network representation representing an aggregated expected network comprising a single node type and a single relationship type by combining multiple node types and relationship types in said multi-relation network representation;
determining a relation between said users based on said at least one categorization criterion and by associating said acquired information with said aggregated expected network; and
updating said multi-relation network representation based on said determined relation;
and
categorize said users according to said determined relation.

20. A computer program product for categorizing users in a communications network, the computer program product being stored on a non-transitory computer readable storage medium and comprising computer program instructions that, when executed by a processing unit, causes the processing unit to:
acquire information from a plurality of information sources in a communications network, said information being associated with a plurality of users of said communications network and represented by a multi-relation network representation, said multi-relation network representation comprising a plurality of node types and relationship types;
acquire at least one categorization criterion;
repeatedly perform a categorization routine comprising:
transforming said multi-relation network representation into a single-relation network representation representing an aggregated expected network comprising a single node type and a single relationship type by combining multiple node types and relationship types in said multi-relation network representation;
determining a relation between said users based on said at least one categorization criterion and by associating said acquired information with said aggregated expected network; and
updating said multi-relation network representation based on said determined relation; and
categorize said users according to said determined relation.
